(19) United States
(12) Patent Application Publication
(10) Pub. No.: US 2024/0430248 A1
(43) Pub. Date: Dec. 26, 2024

(54) SECURE COMMUNICATION CHANNEL INJECTION FOR AUTHENTICATION ACROSS HOSTS WITH N-LEVEL DEEP APPLICATIONS

(71) Applicant: Microsoft Technology Licensing, LLC, Redmond, WA (US)

(72) Inventors: Matthew Steven GEIMER, Everett, WA (US); Jose Julian ARGIL TORRES, Sammamish, WA (US); Daniel SAUNDERS, Redmond, WA (US)

(73) Assignee: Microsoft Technology Licensing, LLC, Redmond, WA (US)

(21) Appl. No.: 18/338,422

(22) Filed: Jun. 21, 2023

(51) Int. Cl. H04L 9/40; H04L 67/02

(52) U.S. Cl. CPC H04L 63/0807; H04L 67/02

(57) ABSTRACT

A data processing system implements receiving a request for an access token from a web-based nested application hosted by a native application, creating a secure authentication channel between the first web-based nested application and the native application that bypasses one or more intermediary nested applications to prevent the one or more intermediary nested applications from accessing data exchanged between the first web-based nested application and the native application; sending the request for the access token to the native application via the secure authentication channel; obtaining the access token from a token service on a remote server over a network connection; providing the access token to the first web-based nested application via the secure authentication channel; sending a request to access the content on the resource server and the access token to the resource server; and performing one or more actions on the content on the resource server.

### BACKGROUND

Nested applications are applications that run within a frame within a host application. Nested applications may be implemented in a web browser or as a hosted experience in a native application. Some software providers create native software applications that include integrations based on web-based application technologies that run in a web browser-like container within the native application. Some implementations include multiple layers of nesting which further complicate the integration of these applications with the host application.

Authentication is particularly challenging in nested applications. Each application may implement different standards and protocols for authentication. Furthermore, even where a standardized protocol is adapted by application developers, problems with interoperability can still arise with different platforms, hosts, and identity service providers. For example, a protocol designed for use in a web-based application may not operate in a web browser-like container in a native application in a nested application scenario.

Establishing trust boundaries between nested applications is also another challenge. Nested applications often have different security concerns. A host application may have access to sensitive information that should not be shared with the nested application, or a nested application may have access to sensitive content that should not be accessible by another nested application. Hence, there is a need for improved systems and methods of providing a secure communication channel for authentication across hosts in nested applications.

### SUMMARY

An example data processing system according to the disclosure includes a processor and a machine-readable medium storing executable instructions. The instructions when executed cause the processor alone or in combination with other processors to perform operations including receiving a request for an access token from a first web-based nested application hosted by a native application on a client device, the access token providing access to content on a resource server remote from the client device; creating a secure authentication channel between the first web-based nested application and the native application, the secure authentication channel bypassing one or more intermediary nested applications between the first web-based nested application and the native application to prevent the one or more intermediary nested applications from accessing data exchanged between the first web-based nested application and the native application; sending the request for the access token to the native application via the secure authentication channel; causing the native application to obtain the access token from a token service on a remote server over a network connection; causing the native application to provide the access token to the first web-based nested application via the secure authentication channel; sending a request to access content on the resource server and the access token from the first web-based application to the resource server; and performing one or more actions on the content on the resource server in response to obtaining access to the content on the resource server.

An example data processing system according to the disclosure includes a processor and a machine-readable medium storing executable instructions. The instructions when executed cause the processor alone or in combination with other processors to perform operations including receiving a request for an access token from a first web-based nested application hosted by a host web-based application in a web browser on a client device, the access token providing access to content on a resource server remote from the client device; creating a secure authentication channel between the first web-based nested application and the host web-based application, the secure authentication channel bypassing one or more intermediary nested applications between the first web-based nested application and the host web-based application to prevent the one or more intermediary nested applications from accessing data exchanged between the first web-based nested application and the host web-based application; sending the request for the access token to the host web-based application via the secure authentication channel; causing the host web-based application to obtain the access token from a token service on a remote server over a network connection; causing the host web-based application to provide the access token to the first web-based nested application via the secure authentication channel; sending a request to access content on the resource server and the access token from the first web-based application to the resource server; and performing one or more actions on the content on the resource server in response to obtaining access to the content on the resource server.

An example method implemented in a data processing system includes receiving a request for an access token from a first web-based nested application hosted by a native application on a client device, the access token providing access to content on a resource server remote from the client device; creating a secure authentication channel between the first web-based nested application and the native application, the secure authentication channel bypassing one or more intermediary nested applications between the first web-based nested application and the native application to prevent the one or more intermediary nested applications from accessing data exchanged between the first web-based nested application and the native application; sending the request for the access token to the native application via the secure authentication channel; causing the native application to obtain the access token from a token service on a remote server over a network connection; causing the native application to provide the access token to the first web-based nested application via the secure authentication channel; sending a request to access content on the resource server and the access token from the first web-based application to the resource server; and performing one or more actions on the content on the resource server in response to obtaining access to the content on the resource server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example of a native application hosting nested applications in which the techniques described herein may be implemented.

FIG. 2 is a diagram showing an example of a browser application hosting nested application in which the techniques described herein may be implemented.

FIG. 3 is a diagram showing an example computing environment in which the techniques herein may be implemented.

FIG. 4 is a diagram showing an example message flow in an implementation of the techniques described herein in a native application hosting nested applications.

FIG. 5 is a sequence diagram showing an example message flow in an implementation of the techniques described herein in a browser hosting nested applications.

FIG. 6 is a sequence diagram showing an example message flow in an implementation of the techniques described herein in a native application hosting nested applications.

FIG. 7 is a sequence diagram showing another example message flow in an implementation of the techniques described herein in a native application hosting nested applications.

FIG. 8 is a sequence diagram showing another example message flow in an implementation of the techniques described herein in a native application hosting nested applications.

FIG. 9A is a flow chart of an example process for providing authentication in a nested application environment in a browser according to the techniques provided herein.

FIG. 9B is a flow chart of an example process for providing authentication in a nested application environment hosted in a native application according to the techniques provided herein.

FIG. 10 is a block diagram showing an example software architecture, various portions of which may be used in conjunction with various hardware architectures herein described, which may implement any of the described features.

FIG. 11 is a block diagram showing components of an example machine configured to read instructions from a machine-readable medium and perform any of the features described herein.

FIG. 12 provides an example of a user interface that may be displayed to obtain consent from the user for the application to access certain data and/or perform certain actions.

### DETAILED DESCRIPTION

Techniques for providing a secure communications channel for authentication across hosts within nested applications. These techniques address the technical problems associated with implementing authentication in nested applications and with imposing frame boundaries that restrict the access to sensitive information by nested applications. The techniques herein support authentication for both nested applications hosted in both web browsers and within native application by implementing a secure authentication channel and a key (referred to herein as an “API key”) to enable access to sensitive information and the application programming interfaces (“APIs”) used to access this sensitive data. A technical benefit of this approach is that the secure authentication channel and the API key facilitate cross-frame isolation that enable trust boundaries to be enforced to reduce cross-frame sharing of information among the host application and nested applications. These and other technical benefits of the techniques disclosed herein will be evident from the discussion of the example implementations that follow.

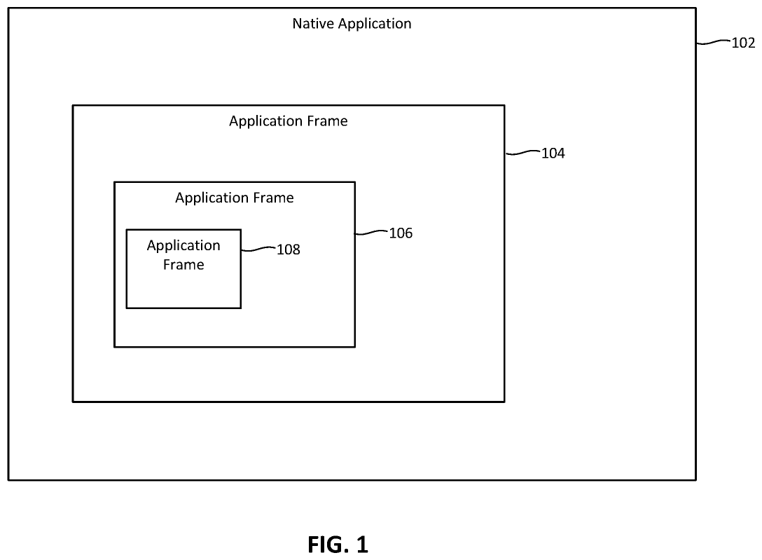

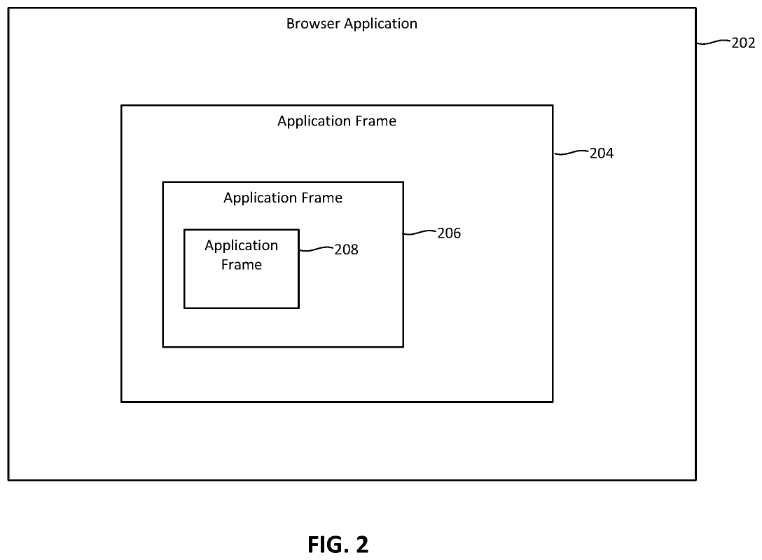

FIG. 1 is an example implementation of a native application 102 that is hosting a nested application 104. The nested application 104 hosts a nested application 106, and the nested application 106 hosts another nested application 108. FIG. 2 is an example implementation of a web browser 202 that is hosting a nested application 204. The nested application 204 hosts another nested application 206, and the nested application 206 hosts a nested application 208. The examples shown in FIGS. 1 and 2 show one example of nested application hosted in a native application and a web browser, respectively. However, other implementations may include a different number of layers of nesting, and multiple applications may be nested at a particular layer. A technical problem associated with such implementations is that an untrusted nested application could attempt to intercept an access token that has been issued to another trusted nested application. As will be discussed in greater detail in the examples which follow, the techniques herein provide a secure authentication channel and API key that facilitate authentication of nested applications and cross-frame isolation to avoid untrusted or less trusted applications from obtaining access to sensitive data and/or APIs.

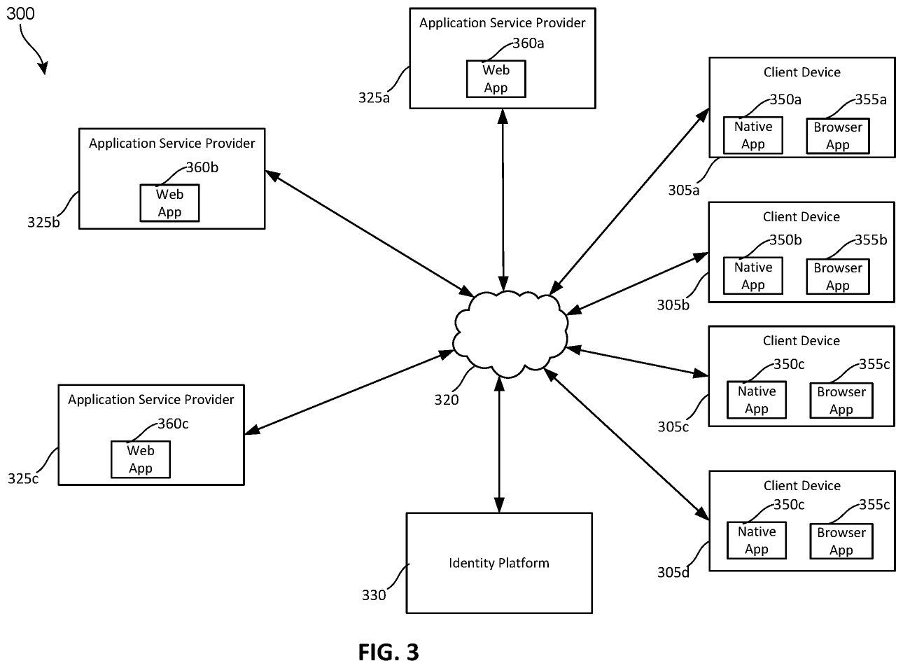

FIG. 3 is a diagram showing an example computing environment 300 in which the techniques disclosed herein for providing a secure communications channel for authentication across hosts within nested applications may be implemented. The computing environment 300 includes application service providers 325a, 325b, and 325c (collectively referred to as application service provider 325). The example computing environment 300 also includes client devices 305a, 305b, 305c, and 305d (collectively referred to as client device 305). The client devices 305a, 305b, 305c, and 305d communicate with the application services providers 325a, 325b, and 325c and/or the identity platform 330 via the network 320. Furthermore, the identity platform 330 communicates with the application service providers 325a, 325b, and 325c via the network 320. The network 320 may be a combination of one or more public and/or private networks and may be implemented at least in part by the Internet.

In the example shown in FIG. 3, the application service providers 325 are implemented as a cloud-based service or set of services. The application service providers 325 may provide one or more applications that are accessible by users via the client devices 305. The applications provided by the application service providers 325 may be nested in another application and/or have another application nested within them. The host application and the applications nested within them may be provided by the same application services provider 325 or by a different application services provider 325. The applications may be hosted within a native application, such the native applications 350a, 350b, and 350c (collectively referred to as native application 350), or hosted in a web browser, such as the browser applications 355a, 355b, and 355c (collectively referred to as browser application 355). While the example implementation shown in FIG. 3 includes three application services providers 325, other implementations may include a different number of application service providers. Furthermore, while each application service provider 325 is shown having a single web application 360, other implementations of the application service providers 325 may implement a different number of web applications 360.

The identity platform 330 implements services for authenticating users to access resources provided by the application service providers 325. The identity platform 330 also implements services for authenticating applications, such as those implemented on the client devices 305 and/or the application service providers 325, to gain access to protected resources. These protected resources can include sensitive data and/or web APIs that cause an application to execute specific functionality. The identity platform 330 can issue various types of tokens, including but not limited to identity tokens and access tokens. Identity tokens include information that indicates what happened when a user was authenticated by the identity platform 330. The identity tokens are meant to be inspected by an application and typically include a header, signature, and payload. The header and signature are used to verify the validity of the token, while the payload includes information about the user for whom the identity token was issued. In contrast with the identity tokens, access tokens are opaque tokens that are used to securely call protected web APIs and/or access sensitive information. Access tokens according to the OAuth specification do not have a fixed format and the format may vary depending upon the configuration of the web API that accepts the access token.

The techniques provided herein provide a secure authentication channel and API key that enable nested applications to securely perform authentication without cross-frame information sharing among the nested applications. The examples which follow describe how these techniques may be implemented in a web browser or a native application on a client device, such as the client devices 305. In some implementations, the functionality of the identity platform 330 described herein may be implemented by one or more of the application service providers 325. In some implementations, the identity platform 330 implements a security token service (STS) that is responsible for issuing, validating, renewing, and canceling security tokens. The security tokens issued by the STS can then be used to identify the holder of the token to the services provided by the application service providers 325. In some implementations, the identity platform 330 is implemented by Microsoft Azure Active Director (AAD)®, which provides an enterprise identity service that provides various authentication services.

The client devices 305 may be used to access the applications provided by the application services providers 325. The client devices 305 may include a web-enabled native application 350 that can host one or more nested applications of the application service provider 325. The client devices 305 may also include a browser application 355 that can be used to access a web application provided by the application service providers 325, such as the web applications 360a, 360b, and 360c (collectively referred to as web applications 360). The web applications 360 can host one or more nested applications having one or more layers of nesting. Similarly, the native application 350 can host one or more of the web applications 360 as nested applications having one or more layers of nesting.

The client devices 305 are each a computing device that may be implemented as a portable electronic device, such as a mobile phone, a tablet computer, a laptop computer, a portable digital assistant device, a portable game console, and/or other such devices. The client devices 305 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 3 includes four client devices, other implementations may include a different number of client devices 305.

The client device 305 includes a web-enabled native application 350 and/or a browser application 355, in some implementations. The native application 350 is configured to communicate with the application service providers 325 to access content provided by the application service providers 325. As discussed in the preceding examples, the native application 350 may host one or more nested web-applications, such as but not limited to the web applications 360 provided by the application services platform 325. The browser application 355 is an application for accessing and viewing web-based content, which may be provided by web applications 360 of the application service providers 325. The browser application 355 may also host nested applications, such as but not limited to the web applications 360.

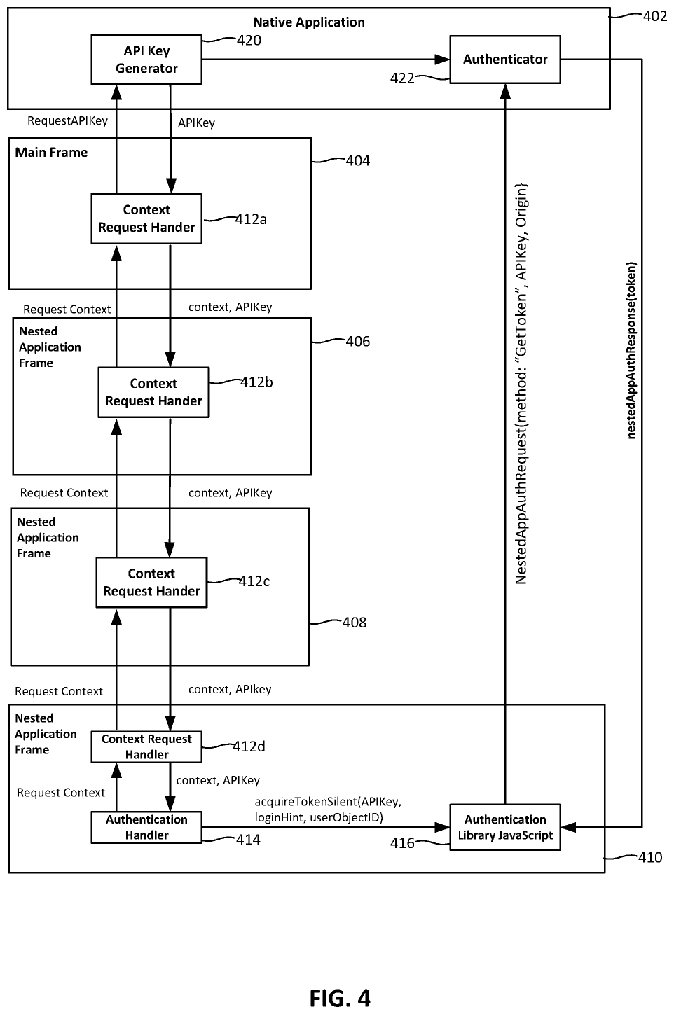

FIG. 4 is a diagram showing an example message flow in an implementation of the techniques described herein in a native application hosting nested applications. The native application may be implemented by the native application 350 on the client device 305 shown in FIG. 3. The message flow shown in FIG. 4 demonstrates how an API key can be obtained by a nested application frame and the API key can the be used by the nested application frame to obtain an access token. In the example shown in FIG. 4, the nested frame acquiring the API key is hosted by a native application. However, a similar process can be implemented in a host frame in browser-based implementation.

The API key is a security feature that restricts which nested applications can acquire an access token using the nested application authentication techniques described herein. Another security feature is that the access token is also only passed through the most trusted source to the nested application frame requesting the access token. In implementations in which the nested applications are hosted by a native application, such as that shown in FIG. 4, the most trusted source is the native application, and the native application handles acquisition of the access token and providing the access token to the nested application frame that requested the access token. In implementations in which the nested application frame is hosted in web browser, the host application in the topmost frame is the most trusted source and handles the acquisition of the access token and providing the access token the nested application frame that initiated the request for the token. Current nested application authentication techniques lack a means for differentiating between token requests originating from an untrusted nested application frame and requests originating from a trusted nested application frame that has established user trust through user consent models. The API key provides a technical solution to this technical problem for nested application authentication in both native application and browser-based implementations.

In the example implementation shown in FIG. 4, the native application 402 hosts main frame 404. The main frame 404 hosts a first nested application in the nested application frame 406. The nested application frame 406 hosts a second nested application in the nested application frame 408, and the nested application frame 408 hosts a third nested application in the nested application frame 410. While the example shown in FIG. 4 includes four levels of nesting, other implementations may implement a different level of nesting of applications.

In the example shown in FIG. 4, the authentication handler 414 of the third nested application hosted in the nested application frame 410 attempts to acquire an access token in this example implementation. Each of the frames implements a context request handler in this example implementation to request context information and the API key. The context information includes a login hint, a user object ID, and tenant ID. The login hint is an opaque value that can be used for single sign-on (SSO) and authentication. The login hint can be obtained from the user's identity token and can be used to bypasses an account selection prompt that would otherwise be presented to the user. The user object ID is a unique identifier assigned to the user. The tenant ID is a unique identifier associated with a customer of a multitenant computing environment to identify the computing and other resources associated with the customer. The context request handler of each frame passes the request for the context information and the API key up to the frame's respective host frame, until the request reaches the main frame 404. The context request handler 412a-412d (collectively referred to as context request handler 412) of each frame determines whether the request for the context information and API key has been received from a trusted frame. If the request has not been received from a trusted frame, the context request handler of the frame receiving the request can deny the request for the API key. The determination whether a particular application frame should be trusted can be made in a number of different ways. In some implementations, each application is associated with a particular URL and each application may maintain a list of trusted application URLs that can be used to determine whether a request for an access token and/or AKI key has originated from a trusted application frame.

The main frame 404 requests the API key from the API key generator 420 of the native application 402. In some implementations, the API key generator 420 generates a Universally Unique Identifier (UUID) to use as the API key. The API key generator 420 stores the API key in a nested application authentication host context object that the authenticator 422 of the native application 402 can use to validate requests that come from deeply nested frames hosted by the native application 402.

The authentication handler 414 of the third nested application attempts to obtain the API key in response to a request to access a web-based API and/or sensitive data from one of the application service providers 325. The authentication handler 414 requests the context information and the API key from the second nested application hosted in the nested application frame 408. As previously discussed, the third application hosted in the nested application frame 410 must be a trusted application in order to obtain the API key required to obtain an access token. In some implementations, the authentication handler 414 executes an acquireTokenSilent method of the authentication library JavaScript 416. In some implementations, the authentication library JavaScript 416 is implemented by the Microsoft Authentication Library for JavaScript (MSAL.js), which enables authentication and token acquisition. MSAL can be used to provide secure access to various web APIs, including but not limited to Microsoft Graph and/or other Microsoft web APIs as well as third-party and developer-created web APIs. The acquireTokenSilent method does not prompt the user of the client device for authorization before attempting to obtain the authentication token. Instead, the login hint, user object ID, the API key, and/or other information is used to determine whether the request for the security token should be granted. The authentication library JavaScript 416 sends a nested application authentication request directly to the authenticator 422 of the native application 402 and bypasses an intervening application frame. The nested application authentication request includes the API key and an indication of the nested application frame that is the source of the request. The authenticator 422 compares the API key received with the request to the API key stored in the nested application authentication host context object. If the API key does not match, the authenticator 422 rejects the request for the access token. However, if the API keys do match, the authenticator 422 of the native application 402 requests the access token from the identity platform 330 and provides the access token to the nested application frame 410 of the third nested application via a nested application authentication response. The third nested application may then utilize the access token to request content from a resource server, such as one of the application service providers 325. The process of obtaining the API shown in FIG. 4 can be implemented in the examples which follow to provide an additional layer of security to the secure authentication channel for obtaining an access token.

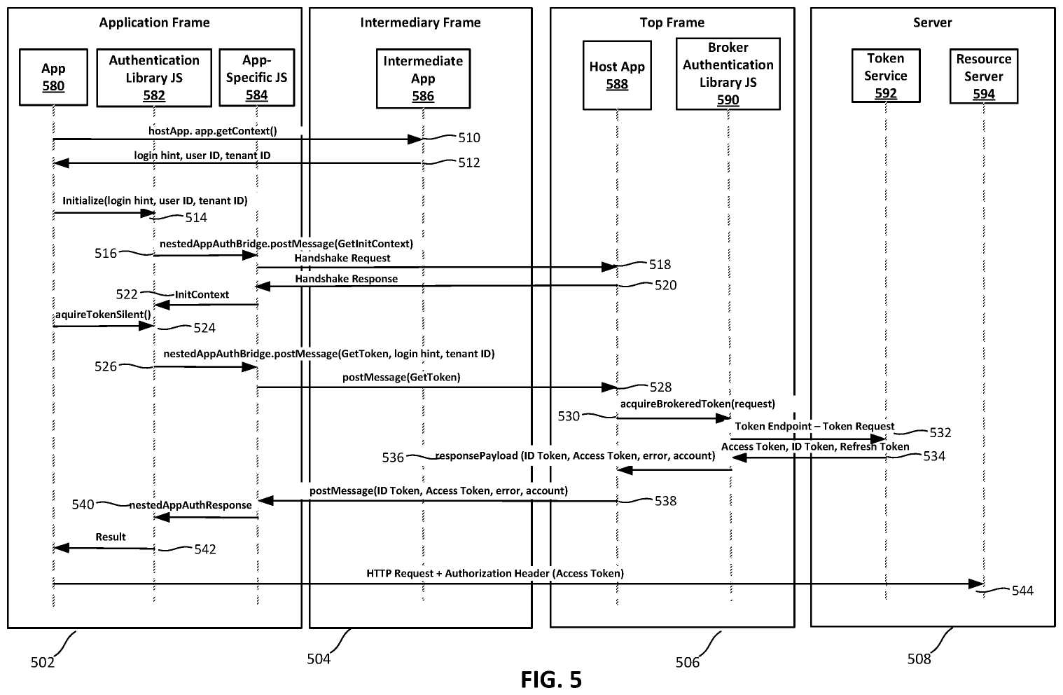

FIG. 5 is a sequence diagram showing an example message flow in an implementation of the techniques described herein in a browser hosting nested applications. The process shown in FIG. 5 may be implemented in the browser application 355 of the client device 305. The process shown in FIG. 5 implements a pairwise broker in the browser 355 using JavaScript to implement the nested application authentication. The JavaScript is used to create a secure authentication channel to obtain access tokens. The secure authentication channel can be used with the API key discussed in FIG. 4 to provide an additional level of security by ensuring that only trusted nested applications are able to obtain an

In the example implementation shown in FIG. 5, the application frame 502 is a nested application frame that is nested in the top frame 506 in the browser application 355 of a client device 305. Specifically, the application frame 502 is nested in the intermediary frame 504, and the intermediary frame 504 is nested in the top frame 506. The application frame 502, the intermediary frame 504, and the top frame 506 are each associated with a different application. These applications are provided by one or more of the application service providers 325. The example shown in FIG. 5 includes an intermediary frame 504, which is optional. Other implementations include more than one intermediary frame, while other implementations omit the intermediary frame entirely and the application frame 502 is hosted by the top frame 506.

In the example shown in FIG. 5, the application 580 associated with the application frame 502 utilizes the secure authentication channel to obtain an access token that permits the application access resources from a resource server, such as the resource server 594 of the application service provider 325 associated with the application. The application frame 502 includes the application 580, authentication library JavaScript 582, and application-specific JavaScript 584. The authentication library JavaScript facilitates authentication using the identity platform 330. In some implementations, the authentication library JavaScript 582 is implemented by the Microsoft Authentication Library for JavaScript (MSAL.js), which enables authentication and token acquisition from the identity platform 330. The application-specific JavaScript 584 is JavaScript associated with the application in the top frame that is accessible by the application frame 502, the intermediary frame 504, and any other frames nested in the top frame 506. The application-specific JavaScript 584 enables the nested frames to request information from the parent frame in which the application is being hosted.

In operation 510, the application 580 uses the get context method to obtain context information that will be used by the broker to determine which account should be used to acquire a token. In operation 512, the intermediate application 586 associated with the intermediary frame 504 returns the requested context information. In this example, the context information includes a login hint, a user object ID, and tenant ID. The login hint is an opaque value that can be used for single sign-on and authentication. The login hint can be obtained from the user's identity token and can be used to bypasses an account selection prompt that would otherwise be presented to the user. The user object ID is a unique identifier assigned to the user. The tenant ID is a unique identifier associated with a tenant of a multitenant computing environment to identify the computing and other resources associated with a customer.

In operation 514, the application calls the initialize method of the authentication library JavaScript 582 and provides login hint, user ID, and tenant ID to initialize the authentication context. In some implementations, an authentication object is instantiated by the authentication library JavaScript 582 based on the login hint, the user ID, and/or the tenant ID. The initialize method also causes the authentication library JavaScript 582 to detect an instance of the nestedAppAuthBridge object in the global context. In some implementations, the nestedAppAuthBridge object is instantiated in the global context by the application-specific JavaScript 584, which is executed when the application frame 502 is instantiated. If, for example, the host application 588 is Microsoft Teams, then the application-specific JavaScript 584 would be the Teams JavaScript (“TeamJS”), the Microsoft Teams specific JavaScript. In other implementations, other application-specific JavaScript may be used, depending on the host application 588. The nestedAppAuthBridge object and the authentication library JavaScript 582 implement the secure authentication channel used to obtain the access token from the token service 592 of the server 508 as discussed below.

In operation 516, the authentication library JavaScript 582 calls the post message method of the nestedAppAuthBridge object. In operations 518, a handshake request is made to the application 588 in the top frame 506, and in operation 520, the application 588 provides a handshake response. In operation 522 context information is provided to enable the application-specific JavaScript 584 to utilize the nestedAppAuthBridge to communicate with the host application 588 in the top frame 506 and bypass any intermediary frames, such as the intermediary frame 504.

In operation 524, the application 580 executes the acquireTokenSilent method in the authentication library JavaScript 582. The authentication library JavaScript 582 checks to see if there is a non-expired access token in the cache and returns that token. If no non-expired access token is found in the cache, then the secure authentication channel is used to obtain an access token. In operation 526, the post message method of the nestedAppAuthBridge is executed to request the token. The post message method parameters includes an indication that the message is a get token request. The login hint and the tenant ID are also provided to identify the user for which the access token is being acquired. When requesting the access token, the authentication library JavaScript 582 uses the nestedAppAuthBridge object to send and receive messages in a similar manner as it would in native brokered authentication, except internally the application-specific JavaScript 584 uses the post message method to communicate with the top frame 506 which acts as the broker for obtaining the access token. In operation 528, the post message method from the application-specific JavaScript 584 is used to communicate directly with the host application 588 of the top frame.

A technical benefit of this approach is that the application frame 502 bypasses any intermediary frames, such as the intermediary frame 504, which may have a different trust boundary and communicates directly with the top frame 506. This is in direct contrast to current approaches in which the messages would travel from the application frame 502 to the top frame 506 through all intermediate frames and responses would travel from the top frame 506 back through all the intermediate frames to the application frame 502. However, this approach is not very secure, and an intermediary frame could attempt to spoof the origin of a requestor to gain access to sensitive data and/or web APIs that the frame should otherwise have been unable to access.

The security of this approach can also be improved through the user of an API key such as that discussed in the preceding example. In some implementations, the host application 588 may provide the API key with the handshake response in operation 520. In other implementations, the application frame 502 may request the API key after the handshake request with the host application 588 is completed. In other implementations, the request for the API key may be passed up through each layer of the nested applications to the host application 588 in the top frame 506, and each successive nested frame of the nested application frames can make a determination whether the preceding frame is a trusted application frame. In yet another approach, the nested application frame 502 sends a request to the top frame 506 for the access token as shown in FIG. 4, but also sends another message that causes the intermediary frame 504 (or other nested application frame at the level below the top frame 506) that is trusted by the top level frame 506 to provide an indication to the top level frame 506 that the application frame 502 is a trusted frame and can be provided with the API key.

The host application 588 requests that the broker application library JavaScript 590 acquire the access token in operation 530. The broker authentication library JavaScript 590 is a modified version of the authentication library JavaScript 582. The broker authentication library JavaScript 590 includes custom logic handling brokered authentication requests. The broker authentication library JavaScript 590 receives requests for authentication tokens (operation 530), executes the requests (operation 532) with the token endpoint of the token service 592, and receives responses from the token service 592 (operation 534) which includes the access token and may also include an identity token and refresh token. In operation 532, the request for the token includes a refresh token, authentication parameters, the client ID, a redirect URL associated with the application 580, and a broker client ID and broker URL associated with the host application 588 which is serving as the pairwise broker for obtaining the access token. The redirect URL is registered with the token service 592 before processing requests for tokens from the application 580 to ensure that the client ID matches the redirect URL provided in the token request. If the redirect URL provided does not match that registered for the client ID, then the request for the token should be denied. Similarly, the broker client ID and broker URL should also match those registered with the token service 592, or the request for the access token should be denied. The refresh token may be cached, and the broker authentication library JavaScript 590 attempts to access the cached refresh token prior to making the request for the access token. The refresh token is a longer-lived token that allows a client application to obtain new access tokens without requiring the user to log in again. Using refresh tokens allows the access tokens expire in a short time after issuance to make it less likely that unauthorized applications, such as from an untrusted frame, could obtain and use an access token. The token service 592 may be implemented by the identity platform 330 discussed in the preceding examples for issuing, validating, renewing, and canceling security tokens.

The response is provided to the host application 588 in operation 536, and the host application 588 executes a postMessage to provide the access token and/or other results received to the application frame 502. Once again, the postMessage is used to bypass any intermediary frames between the application frame 502 and the top frame 506, to ensure that the trust boundaries are maintained. In operations 540 and 542, the response including the token is provided to the application 580. Once the application 580 has received the access token, the application 580 can use the access token to make a request to access content of the resource server 594. In operation 544, the application 580 makes an HTTP request with an authentication header to the resource server. In the example shown in FIG. 5, the resource server 594 is shown as being implemented on the same server 508 as the token service 592. However, as discussed in the preceding examples, the token service 592 may be implemented by the identity platform 330 and the resource server 594 may be implemented on an application service provider 325.

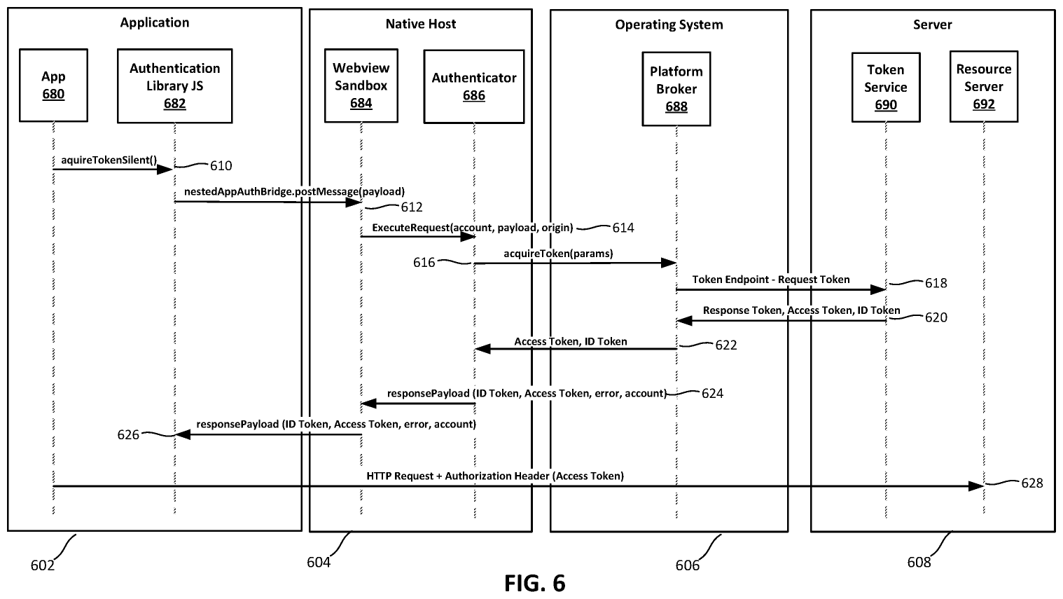

FIG. 6 is a sequence diagram showing an example message flow in an implementation of the techniques described herein in a native application hosting nested applications. The application frame 602 is hosted by native host frame 604 in this example. The operating system 606 of the client device 305 serves as a broker for obtaining the authentication token in this example implementation. The native host 604 is implemented by the native application 350 of the client device 305 shown in FIG. 3 in some implementations.

While the implementation shown in FIG. 6 includes a single application 680 being hosted by the native host frame 604, other implementations can include multiple layers of nested applications between the application 680 in the application frame 602 and the native host frame 604. In such implementations, the nestedAppAuthBridge protects the requests for the access tokens and the responses exchanged between the application frame 602 and the native host frame 604 by using the post message technique discussed in the preceding examples. Any intervening frames would be unable to intercept the requests or the responses that include the requested access token.

The implementation shown in FIG. 6 can also utilize the API key shown in FIG. 4. The native host can implement the API key generation 420 shown in FIG. 4, and the application frame 602 can request the API key from the native host 604. The request for the API key would be routed passed upward from the application frame 602 through any intervening frames to the native host frame 604 as shown in FIG. 4. The native application could also implement the authenticator 422 which is configured to receive the API key as a parameter of any requests for an access token and only request the access token on behalf of the application 680 if the API key matches the expected value. A technical benefit of this approach is that it prevents an untrusted application frame from obtaining an access token.

In operation 610, the application 680 calls the acquireTokenSilent method of the authentication library JavaScript 682. As discussed in the preceding examples, the authentication library JavaScript 682 facilitates authentication using the identity platform 330, and the authentication library JavaScript 682 is implemented by the Microsoft Authentication Library for JavaScript (MSAL.js) in some implementations. In operation 612, the authentication library JavaScript 682 uses the nestedAppAuthBridge object in the global context that the application-specific JavaScript 584 and calls post message method to communicate with the native host frame 604. The application frame 602 is implemented in the webview sandbox 684, which provides a container for displaying the web-based content of the application 680. The webview sandbox 684 sends a request to authenticator 686 in operation 614. The authenticator 686 coordinates with the platform broker 688 implemented by the operating system 606 of the client device 305. In some implementations the authenticator 686 is implemented using the OneAuth application. Other implementations may utilize a different authenticator for obtaining the access token. The authenticator 686 sends an acquire token request to the platform broker 688 implemented by the operating system 606 of the client device 305. The platform broker 688 requests the access token from the token endpoint in operation 618 and receives the access token from the token endpoint of the token service 690 in operation 620. In operation 620, the request for the token includes a refresh token, authentication parameters, the client ID, a redirect URL associated with the application 680, and a broker client ID and broker URL associated with the platform broker 688 of the operating system 606 of the client device 305 which is serving as the broker for obtaining the access token. The redirect URL is registered with the token service 690 before processing requests for tokens from the application 680 to ensure that the client ID matches the redirect URL provided in the token request. If the redirect URL provided does not match that registered for the client ID, then the request for the token should be denied. Similarly, the broker client ID and broker URL should also match those registered with the token service 690, or the request for the access token should be denied. The refresh token may be cached, and the platform broker 688 attempts to access the cached refresh token prior to making the request for the access token.

The platform broker 688 provides the access token to the authenticator 686 in operation 622, which then provides the access token and other data received from the token service 690 to the webview sandbox 684 in operation 624. The response is provided to the application 680 from the native host frame 604 in operation 626. Once the application 680 has received the access token, the application 680 can use the access token to make a request to access content of the resource server 692. In operation 628, the application 680 makes an HTTP request with an authentication header to the resource server. In the example shown in FIG. 6, the resource server 692 is shown as being implemented on the same server 608 as the token service 690. However, as discussed in the preceding examples, the token service 690 may be implemented by the identity platform 330 and the resource server 692 may be implemented on an application service provider 325.

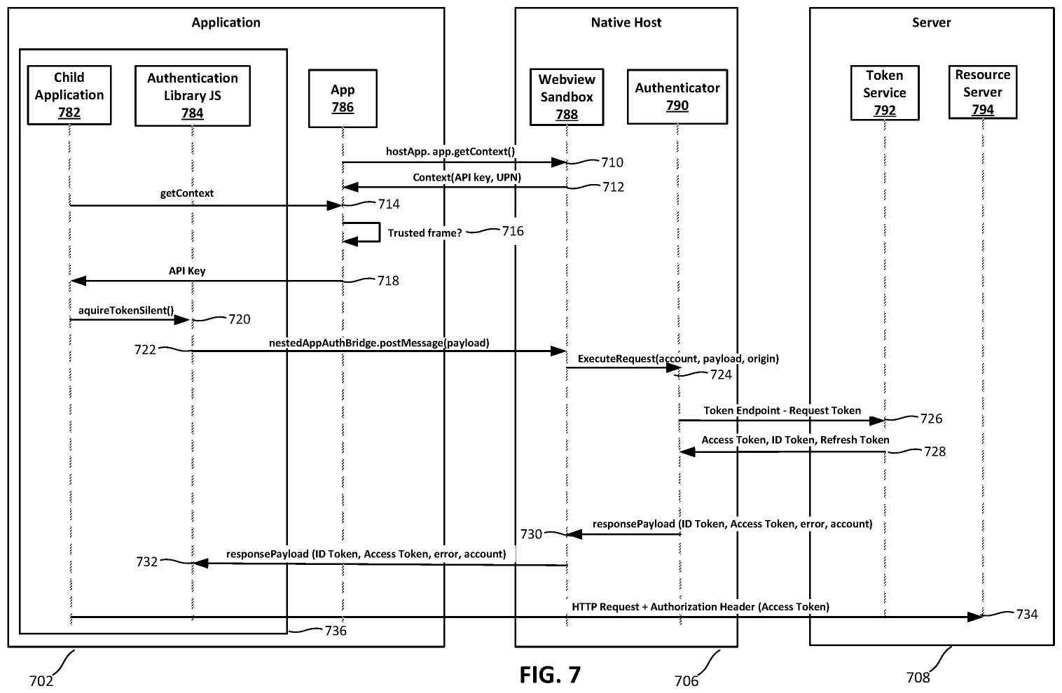

FIG. 7 is a sequence diagram showing another example message flow in an implementation of the techniques described herein in a native application hosting nested applications. The example shown in FIG. 7 builds on the example implementation shown in FIG. 6. The example shown in FIG. 7 includes a deeply nested application where the nested applications are being hosted on a native application, such as the native application 350 of a client device 305. The child application 782 is being hosted in frame 736 by the application 786, and the application 786 is in turn hosted in a frame 702 by the native host application 706. This example implementation includes the use of an API key as an additional security measure. The API key may be obtained from an AKI generator implemented by the native host 706 as discussed in example shown in FIG. 4. The API key adds additional restrictions on which sources can utilize the nested application authentication provided by the secure authentication channel to acquire an access token, while still ensuring that the access token may only be passed through the most trusted source—the native application 706 hosting the nested applications 782 and 786.

The application 786 gets application context information and the API key from the webview sandbox 788 implemented on the native host application 706 in operations 710 and 712. The child application 782 will need this information to directly communicate with the native host application in order to obtain the access token.

The child application 782 request context information from the application 786 in order to obtain the information needed to obtain the access token. The application 786 makes a determination whether the child application 782 is trusted in operation 716. If the child application 782 does not have at least the same trust level as the application 786, then the application 786 will deny the request. Otherwise, the application 786 provides the API key 718 to the child application 782, and the child application 782 executes the acquireTokenSilent method of the authentication library JavaScript 784 in operation 720. As discussed in the preceding examples, the authentication library JavaScript 784 facilitates authentication using the identity platform 330, and the authentication library JavaScript 582 is implemented by the Microsoft Authentication Library for JavaScript (MSAL.js) in some implementations. The acquireTokenSilent method does not prompt the user of the client device for authorization before attempting to obtain the authentication token. In the example shown in FIG. 7 such authorization is requested from the user.

In operation 722, the postMessage method of the nestedAppAuthBridge is executed to request the access token, and the request is provided to the webview sandbox 788 on the native host 706. The webview sandbox 788 sends a request to the authenticator 790 in operation 724. As discussed in the preceding examples, the authenticator 790 is implemented by OneAuth in some implementations. The authenticator 790 requests the access token from the token endpoint of the token service 792 in operation 726 and receives the access token from the token endpoint of the token service 792 in operation 728. In operation 726, the request for the token includes a refresh token, authentication parameters, the client ID, a redirect URL associated with the child application 782, and a broker client ID and broker URL associated with the native host 706. The redirect URL is registered with the token service 792 before processing requests for tokens from the application 782 to ensure that the client ID matches the redirect URL provided in the token request. If the redirect URL provided does not match that registered for the client ID, then the request for the token should be denied. Similarly, the broker client ID and broker URL should also match those registered with the token service 792, or the request for the access token should be denied. The refresh token may be cached, and the broker authentication library JavaScript 590 attempts to access the cached refresh token prior to making the request for the access token. The refresh token is a longer-lived token that allows a client application to obtain new access tokens without requiring the user to log in again. Using refresh tokens allows the access tokens expire in a short time after issuance to make it less likely that unauthorized applications, such as from an untrusted frame, could obtain and use an access token. The token service 792 may be implemented by the identity platform 330 discussed in the preceding examples for issuing, validating, renewing, and canceling security tokens.

The token service 792 provides the access token to the authenticator 790 in operation 728. The token service 792 may also provide an identity token and refresh token to the authenticator 790. The authenticator 790 then provides the access token and other data, such as but not limited to the identity token, account information, and any error information, received from the token service 792 to the webview sandbox 788 in operation 728. The response including the access token is then provided to the child application frame 736 directly from the webview sandbox 788 in operation 732. The child application frame 736 communicates directly with webview sandbox 788 in the native application 706 to send the request for the access token and to receive the response. A technical benefit of this approach is that the access token and/or other information received from the server 708 is not exposed to the intervening frames, such as the application frame 702 in this example implementation.

In operation 734, the child application 782 makes an HTTP request with an authentication header to the resource server 794. In the example shown in FIG. 7, the resource server 794 is shown as being implemented on the same server 708 as the token service 792. However, as discussed in the preceding examples, the token service 792 may be implemented by the identity platform 330 and the resource server 794 may be implemented on an application service provider 325.

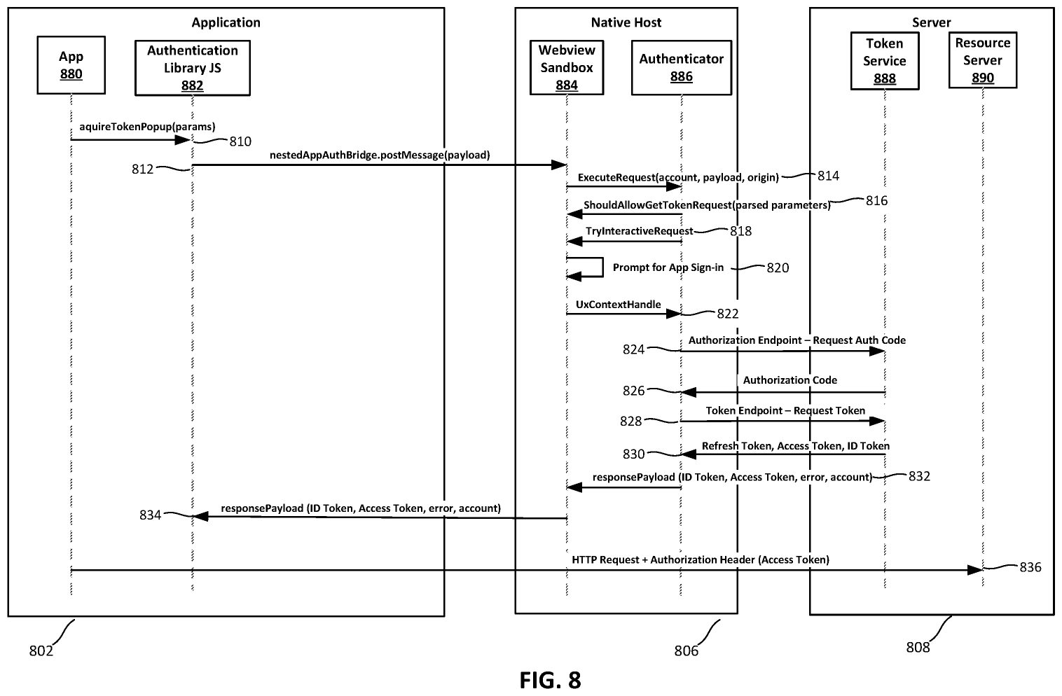

FIG. 8 is a sequence diagram showing another example message flow in an implementation of the techniques described herein in a native application hosting nested applications. The process shown in FIG. 8 provides an example of an application making a brokered authentication request when an interactive flow that involves user content is required. In the example implementation shown in FIG. 8, the application frame 802 is hosted in the native host application 806. The native host 806 is implemented by the native application 350 of the client device 305 shown in FIG. 3 in some implementations.

While the implementation shown in FIG. 8 includes a single application 880 being hosted by the native host application 806, other implementations can include multiple layers of nested applications between the application 880 in the nested frame 802 and the native host frame 806. In such implementations, the nestedAppAuthBridge protects the requests for the access tokens and the responses exchanged between the application frame 802 and the native host frame 806 by using the post message technique discussed in the preceding examples. Any intervening frames would be unable to intercept the requests or the responses that include the requested access token.

The implementation shown in FIG. 8 can also utilize the API key shown in FIG. 4. The native host 806 can implement the API key generation 420 shown in FIG. 4, and the application frame 802 can request the API key from the native host 806. The request for the API key would be routed passed upward from the application frame 802 through any intervening frames to the native host frame 806 as shown in FIG. 4. The native application could also implement the authenticator 422 which is configured to receive the API key as a parameter of any requests for an access token and only request the access token on behalf of the application 880 if the API key matches the expected value. A technical benefit of this approach is that it prevents an untrusted application frame from obtaining an access token.

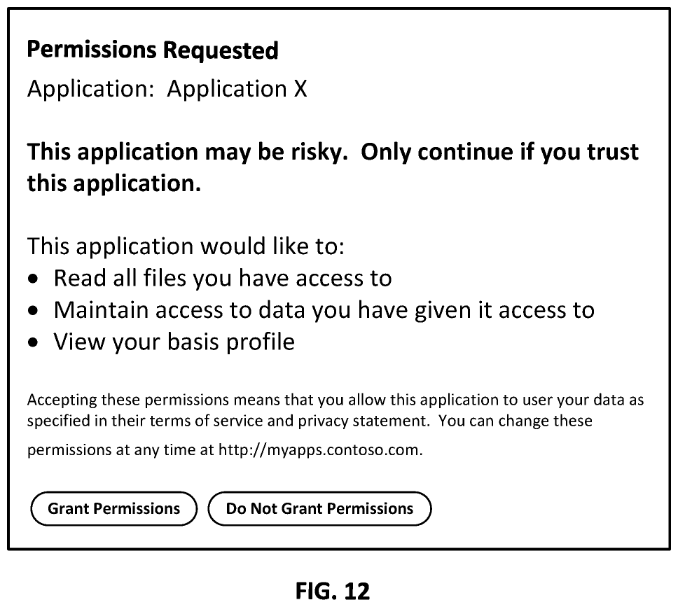

In operations 810 and 812, the application frame 802 initiates the process of attempting to obtain an access token. The postMessage method of the nestedAppAuthBridge is executed to request the token, and in operation 828, and the web sandbox 884 executes a request to the authenticator 886 to execute the request for the access token in operation 814. As discussed in the preceding examples, the authenticator 886 may be implemented using OneAuth. In operation 816, the authenticator 886 determines whether the get token request should be allowed, and if allowed, Authenticator 886 initiates an interactive request to obtain user consent in operation 818. The user is presented with a popup window that indicates that the application 880 is requesting permission to permit the application 880 to access certain data and/or perform certain actions on this data. In operation 822, the UxContextHandle is provided to the authenticator 886 to cause the popup to be displayed on a user interface of the client device 305. FIG. 12 provides an example of such a popup that may be displayed to obtain consent from the user for the application to access certain data and/or perform certain actions.

Authenticator 886 requests the authorization code from the authorization endpoint of the token service 888 in operation 824 and receives the authorization code from the token service 888 in operation 826. The authorization code is received in response to the user granting permission for the application 880 to perform the specified actions. The authorization code is exchanged for the access token. Authenticator 886 then requests the access token from the token endpoint of the token service 888 in operation 828, and the token service 888 provides the response payload including the access token and/or other data to Authenticator 886 in operation 830. Authenticator 886 provides the response payload including the access token and/or other data to the webview sandbox 884, and the webview sandbox 884 provides the response payload to the authentication library JavaScript 882 of the application frame 802. A technical benefit of this approach is that the access token and/or other information received from the server 808 is not exposed to the intervening frames between the native host application 806 and the application frame 802.

In operation 836, the application 880 makes an HTTP request with an authentication header to the resource server 890. In the example shown in FIG. 8, the resource server 890 is shown as being implemented on the same server 808 as the token service 888. However, as discussed in the preceding examples, the token service 888 may be implemented by the identity platform 330 and the resource server 890 may be implemented on an application service provider 325.

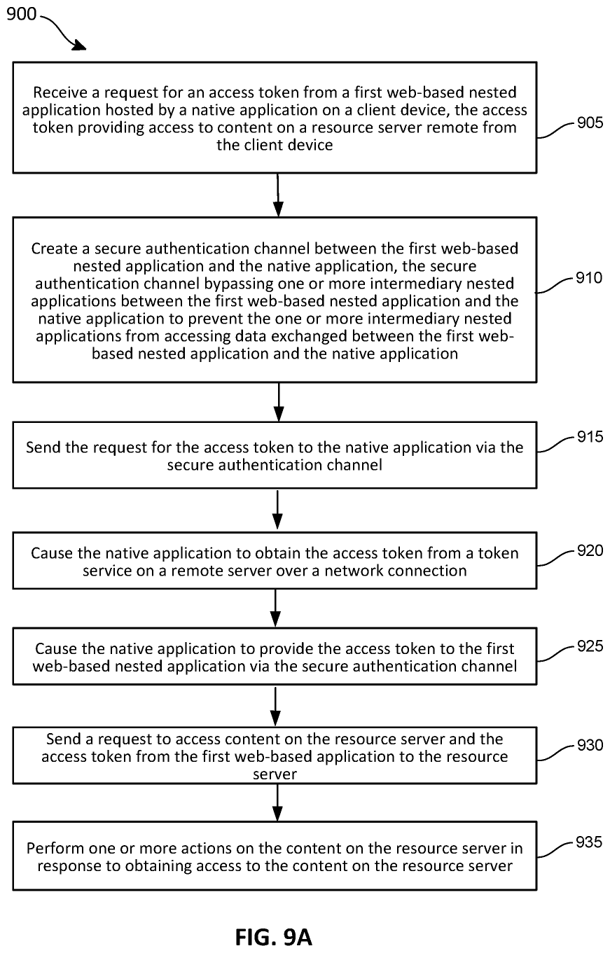

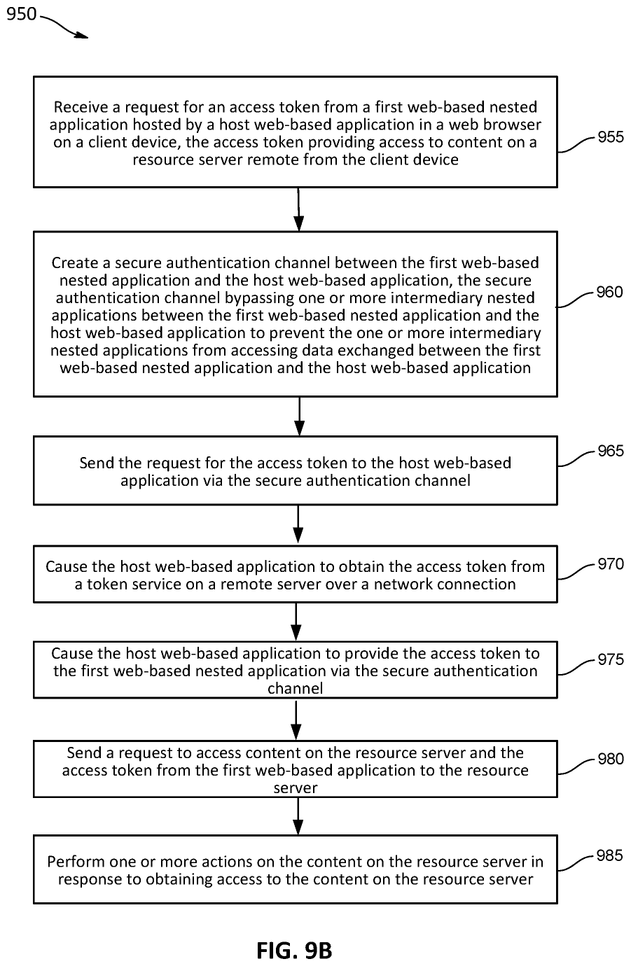

FIG. 9A is a flow chart of an example process 900 for providing a secure communications channel for authentication across hosts within nested applications. The process 900 may be implemented by the client device 305 using the techniques described in the preceding examples and can be used for nested applications that are hosted by a native application.

The process 900 includes an operation 905 of receiving a request for an access token from a first web-based nested application hosted by a native application on a client device. The access token provides access to content on a resource server remote from the client device. As discussed in the preceding examples, a nested application may request an access token for accessing content on a resource server. In implementations in which the nested application is hosted by a native application, the native application facilitates obtaining the access token on behalf of the nested application.

The process 900 includes an operation 910 of creating a secure authentication channel between the first web-based nested application and the native application. The secure authentication channel bypasses one or more intermediary nested applications between the first web-based nested application and the native application to prevent the one or more intermediary nested applications from accessing data exchanged between the first web-based nested application and the native application. The preceding examples provide various implementations of the secure communication channel that are implemented using JavaScript and the nestedAppAuthBridge object to communicate in securely.

The process 900 includes an operation 915 of sending the request for the access token to the native application via the secure authentication channel and an operation 920 of causing the native application to obtain the access token from a token service on a remote server over a network connection. As discussed in the preceding examples, the token is requested and obtained from the token endpoint of the token service.

The process 900 includes an operation 925 of causing the native application to provide the access token to the first web-based nested application via the secure authentication channel. The access token and/or other data obtained from the token service is provided to the first web-based nested application using the secure communication channel to prevent other nested applications from obtaining the access token and/or other data.

The process 900 includes an operation 930 of sending a request to access content on the resource server and the access token from the first web-based application to the resource server and an operation 935 of performing one or more actions on the content on the resource server in response to obtaining access to the content on the resource server. As discussed in the preceding examples, the first web-based application can send an HTTP request to the resources server that includes the access token that permits the web-based application to access the web API and/or other content provided by the resource server.

FIG. 9B is a flow chart of an example process 950 for providing a secure communications channel for authentication across hosts within nested applications. The process 950 may be implemented by the client device 305 using the techniques described in the preceding examples and can be used for nested applications that are hosted in a web browser on the client device 305.

The process 950 includes an operation 955 of receiving a request for an access token from a first web-based nested application hosted by a host web-based application in a web browser on a client device. The access token provides access to content on a resource server remote from the client device. As discussed in the preceding examples, a nested application may request an access token for accessing content on a resource server. In implementations in which the nested application is hosted by a host web-based application in a browser application, the host web-based application facilitates obtaining the access token on behalf of the nested application.

The process 950 includes an operation 960 of creating a secure authentication channel between the first web-based nested application and the host web-based application. The secure authentication channel bypasses one or more intermediary nested applications between the first web-based nested application and the host web-based application to prevent the one or more intermediary nested applications from accessing data exchanged between the first web-based nested application and the host web-based application. The preceding examples provide various implementations of the secure communication channel that are implemented using JavaScript and the nestedAppAuthBridge object to communicate in securely.

The process 950 includes an operation 965 of sending the request for the access token to the host web-based application via the secure authentication channel and an operation 970 of causing the host web-based application to obtain the access token from a token service on a remote server over a network connection. As discussed in the preceding examples, the token is requested and obtained from the token endpoint of the token service.

The process 950 includes an operation 975 of causing the host web-based application to provide the access token to the first web-based nested application via the secure authentication channel. The access token and/or other data obtained from the token service is provided to the first web-based nested application using the secure communication channel to prevent other nested applications from obtaining the access token and/or other data.

The process 950 includes an operation 980 of sending a request to access content on the resource server and the access token from the first web-based application to the resource server and an operation 985 of performing one or more actions on the content on the resource server in response to obtaining access to the content on the resource server. As discussed in the preceding examples, the first web-based application can send an HTTP request to the resources server that includes the access token that permits the web-based application to access the web API and/or other content provided by the resource server.

The detailed examples of systems, devices, and techniques described in connection with FIGS. 1-9B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-9B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

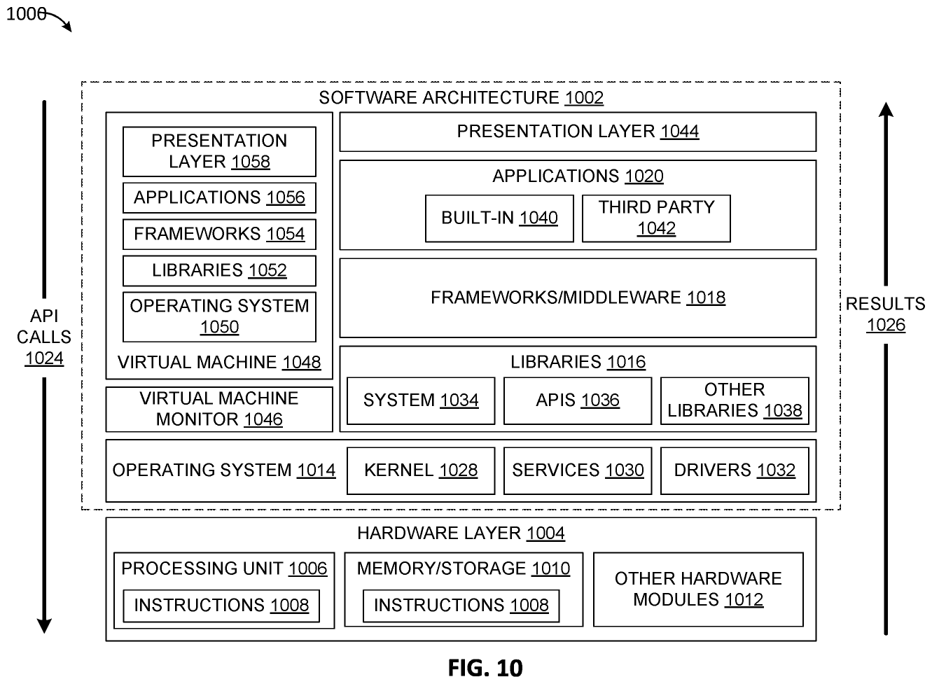

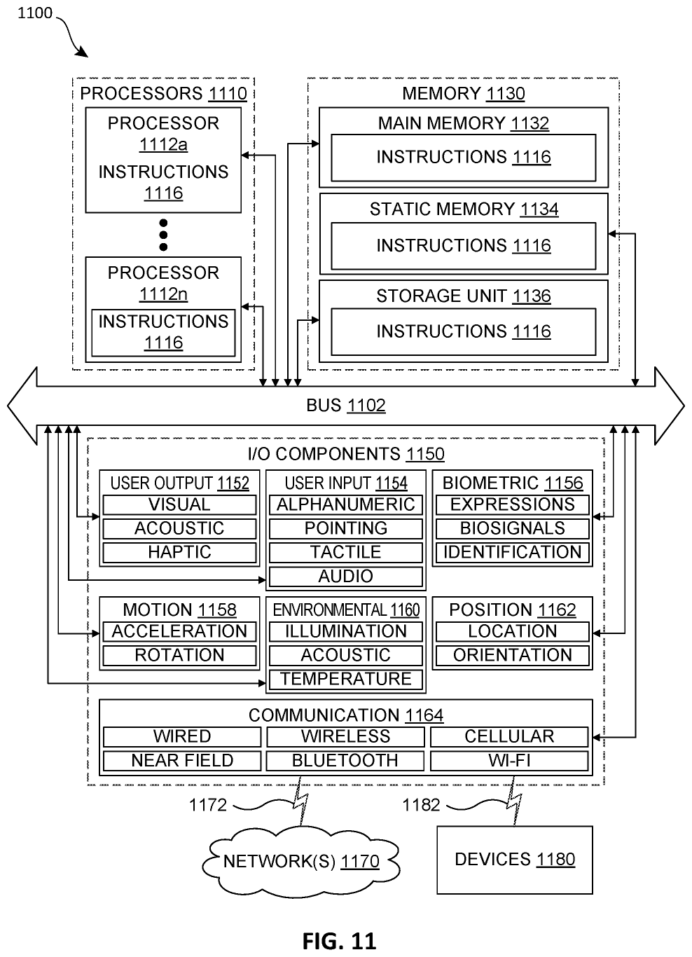

FIG. 10 is a block diagram 1000 illustrating an example software architecture 1002, various portions of which may be used in conjunction with various hardware architectures herein described, which may implement any of the above-described features. FIG. 10 is a non-limiting example of a software architecture, and it will be appreciated that many other architectures may be implemented to facilitate the functionality described herein. The software architecture 1002 may execute on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 includes a processing unit 1006 and associated executable instructions 1008. The executable instructions 1008 represent executable instructions of the software architecture 1002, including implementation of the methods, modules and so forth described herein. The hardware layer 1004 also includes a memory/storage 1010, which also includes the executable instructions 1008 and accompanying data. The hardware layer 1004 may also include other hardware modules 1012. Instructions 1008 held by processing unit 1006 may be portions of instructions 1008 held by the memory/storage 1010.

The example software architecture 1002 may be conceptualized as layers, each providing various functionality. For example, the software architecture 1002 may include layers and components such as an operating system (OS) 1014, libraries 1016, frameworks 1018, applications 1020, and a presentation layer 1044. Operationally, the applications 1020 and/or other components within the layers may invoke API calls 1024 to other layers and receive corresponding results 1026. The layers illustrated are representative in nature and other software architectures may include additional or different layers. For example, some mobile or special purpose operating systems may not provide the frameworks/middleware 1018.

The OS 1014 may manage hardware resources and provide common services. The OS 1014 may include, for example, a kernel 1028, services 1030, and drivers 1032. The kernel 1028 may act as an abstraction layer between the hardware layer 1004 and other software layers. For example, the kernel 1028 may be responsible for memory management, processor management (for example, scheduling), component management, networking, security settings, and so on. The services 1030 may provide other common services for the other software layers. The drivers 1032 may be responsible for controlling or interfacing with the underlying hardware layer 1004. For instance, the drivers 1032 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1016 may provide a common infrastructure that may be used by the applications 1020 and/or other components and/or layers. The libraries 1016 typically provide functionality for use by other software modules to perform tasks, rather than rather than interacting directly with the OS 1014. The libraries 1016 may include system libraries 1034 (for example, C standard library) that may provide functions such as memory allocation, string manipulation, file operations. In addition, the libraries 1016 may include API libraries 1036 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1016 may also include a wide variety of other libraries 1038 to provide many functions for applications 1020 and other software modules.

The frameworks 1018 (also sometimes referred to as middleware) provide a higher-level common infrastructure that may be used by the applications 1020 and/or other software modules. For example, the frameworks 1018 may provide various graphic user interface (GUI) functions, high-level resource management, or high-level location services. The frameworks 1018 may provide a broad spectrum of other APIs for applications 1020 and/or other software modules.

The applications 1020 include built-in applications 1040 and/or third-party applications 1042. Examples of built-in applications 1040 may include, but are not limited to, a contacts application, a browser application, a location application, a media application, a messaging application, and/or a game application. Third-party applications 1042 may include any applications developed by an entity other than the vendor of the particular platform. The applications 1020 may use functions available via OS 1014, libraries 1016, frameworks 1018, and presentation layer 1044 to create user interfaces to interact with users.

Some software architectures use virtual machines, as illustrated by a virtual machine 1048. The virtual machine 1048 provides an execution environment where applications/modules can execute as if they were executing on a hardware machine (such as the machine 1100 of FIG. 11, for example). The virtual machine 1048 may be hosted by a host OS (for example, OS 1014) or hypervisor, and may have a virtual machine monitor 1046 which manages operation of the virtual machine 1048 and interoperation with the host operating system. A software architecture, which may be different from software architecture 1002 outside of the virtual machine, executes within the virtual machine 1048 such as an OS 1050, libraries 1052, frameworks 1054, applications 1056, and/or a presentation layer 1058.

FIG. 11 is a block diagram illustrating components of an example machine 1100 configured to read instructions from a machine-readable medium (for example, a machine-readable storage medium) and perform any of the features described herein. The example machine 1100 is in a form of a computer system, within which instructions 1116 (for example, in the form of software components) for causing the machine 1100 to perform any of the features described herein may be executed. As such, the instructions 1116 may be used to implement modules or components described herein. The instructions 1116 cause unprogrammed and/or unconfigured machine 1100 to operate as a particular machine configured to carry out the described features. The machine 1100 may be configured to operate as a standalone device or may be coupled (for example, networked) to other machines. In a networked deployment, the machine 1100 may operate in the capacity of a server machine or a client machine in a server-client network environment, or as a node in a peer-to-peer or distributed network environment. Machine 1100 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1100 is illustrated, the term “machine” includes a collection of machines that individually or jointly execute the instructions 1116.

The machine 1100 may include processors 1110, memory 1130, and I/O components 1150, which may be communicatively coupled via, for example, a bus 1102. The bus 1102 may include multiple buses coupling various elements of machine 1100 via various bus technologies and protocols. In an example, the processors 1110 (including, for example, a central processing unit (CPU), a graphics processing unit (GPU), a digital signal processor (DSP), an ASIC, or a suitable combination thereof) may include one or more processors 1112a to 1112n that may execute the instructions 1116 and process data. In some examples, one or more processors 1110 may execute instructions provided or identified by one or more other processors 1110. The term “processor” includes a multi-core processor including cores that may execute instructions contemporaneously. Although FIG. 11 shows multiple processors, the machine 1100 may include a single processor with a single core, a single processor with multiple cores (for example, a multi-core processor), multiple processors each with a single core, multiple processors each with multiple cores, or any combination thereof. In some examples, the machine 1100 may include multiple processors distributed among multiple machines.

The memory/storage 1130 may include a main memory 1132, a static memory 1134, or other memory, and a storage unit 1136, both accessible to the processors 1110 such as via the bus 1102. The storage unit 1136 and memory 1132, 1134 store instructions 1116 embodying any one or more of the functions described herein. The memory/storage 1130 may also store temporary, intermediate, and/or long-term data for processors 1110. The instructions 1116 may also reside, completely or partially, within the memory 1132, 1134, within the storage unit 1136, within at least one of the processors 1110 (for example, within a command buffer or cache memory), within memory at least one of I/O components 1150, or any suitable combination thereof, during execution thereof. Accordingly, the memory 1132, 1134, the storage unit 1136, memory in processors 1110, and memory in I/O components 1150 are examples of machine-readable media.

As used herein, “machine-readable medium” refers to a device able to temporarily or permanently store instructions and data that cause machine 1100 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1116) for execution by a machine 1100 such that the instructions, when executed by one or more processors 1110 of the machine 1100, cause the machine 1100 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1150 may include a wide variety of hardware components adapted to receive input, provide output, produce output, transmit information, exchange information, capture measurements, and so on. The specific I/O components 1150 included in a particular machine will depend on the type and/or function of the machine. For example, mobile devices such as mobile phones may include a touch input device, whereas a headless server or IoT device may not include such a touch input device. The particular examples of I/O components illustrated in FIG. 11 are in no way limiting, and other types of components may be included in machine 1100. The grouping of I/O components 1150 are merely for simplifying this discussion, and the grouping is in no way limiting. In various examples, the I/O components 1150 may include user output components 1152 and user input components 1154. User output components 1152 may include, for example, display components for displaying information (for example, a liquid crystal display (LCD) or a projector), acoustic components (for example, speakers), haptic components (for example, a vibratory motor or force-feedback device), and/or other signal generators. User input components 1154 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1150 may include biometric components 1156, motion components 1158, environmental components 1160, and/or position components 1162, among a wide array of other physical sensor components. The biometric components 1156 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1158 may include, for example, acceleration sensors (for example, an accelerometer) and rotation sensors (for example, a gyroscope). The environmental components 1160 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1162 may include, for example, location sensors (for example, a Global Position System (GPS) receiver), altitude sensors (for example, an air pressure sensor from which altitude may be derived), and/or orientation sensors (for example, magnetometers).

The I/O components 1150 may include communication components 1164, implementing a wide variety of technologies operable to couple the machine 1100 to network(s) 1170 and/or device(s) 1180 via respective communicative couplings 1172 and 1182. The communication components 1164 may include one or more network interface components or other suitable devices to interface with the network(s) 1170. The communication components 1164 may include, for example, components adapted to provide wired communication, wireless communication, cellular communication, Near Field Communication (NFC), Bluetooth communication, Wi-Fi, and/or communication via other modalities. The device(s) 1180 may include other machines or various peripheral devices (for example, coupled via USB).

In some examples, the communication components 1164 may detect identifiers or include components adapted to detect identifiers. For example, the communication components 1164 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1164, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor alone or in combination with other processors to perform operations of:
receiving a request for an access token from a first web-based nested application hosted by a native application on a client device, the access token providing access to content on a resource server remote from the client device;
creating a secure authentication channel between the first web-based nested application and the native application, the secure authentication channel bypassing one or more intermediary nested applications between the first web-based nested application and the native application to prevent the one or more intermediary nested applications from accessing data exchanged between the first web-based nested application and the native application;
sending the request for the access token to the native application via the secure authentication channel;
causing the native application to obtain the access token from a token service on a remote server over a network connection;
causing the native application to provide the access token to the first web-based nested application via the secure authentication channel;
sending a request to access content on the resource server and the access token from the first web-based application to the resource server; and
performing one or more actions on the content on the resource server in response to obtaining access to the content on the resource server.

2. The data processing system of claim 1, wherein secure authentication channel is implemented using JavaScript to establish communications between the first web-based application and the native application.

3. The data processing system of claim 1, wherein the machine-readable storage medium further includes instructions configured to cause the processor alone or in combination with other processors to perform operations of:
obtaining an application programmer interface (API) key from the native application, the API key being a unique identifier that is provided to trusted nested applications to permit the trusted nested applications to request and receive access tokens.

4. The data processing system of claim 3, wherein the machine-readable storage medium further includes instructions configured to cause the processor alone or in combination with other processors to perform operations of:
generating the API key using a key generator of the native application, wherein the API key is a Universally Unique Identifier (UUID).

5. The data processing system of claim 4, wherein the machine-readable storage medium further includes instructions configured to cause the processor alone or in combination with other processors to perform operations of:
determining that the first web-based application is included in a list of applications trusted by the native application; and
providing the API key to the first web-based application responsive to determining that the first web-based application is included in the list of applications trusted by the native application.

6. The data processing system of claim 1, wherein the machine-readable storage medium further includes instructions configured to cause the processor alone or in combination with other processors to perform operations of:
obtaining context information from an intermediate nested frame disposed between the first web-based application and the native application, the context information including information for establishing the secure authentication channel between the first web-based application and the native application.

7. The data processing system of claim 1, causing the native application to obtain the access token from a token service on a remote server over a network connection further comprises:
sending a request to a platform broker implemented by an operating system of the client device to obtain the access token; and
receiving the access token from the platform broker implemented by the operating system of the client device.

8. A method implemented in a data processing system for providing a secure communication channel for authentication across hosts within nested applications, the method comprising:
receiving a request for an access token from a first web-based nested application hosted by a native application on a client device, the access token providing access to content on a resource server remote from the client device;
creating a secure authentication channel between the first web-based nested application and the native application, the secure authentication channel bypassing one or more intermediary nested applications between the first web-based nested application and the native application to prevent the one or more intermediary nested applications from accessing data exchanged between the first web-based nested application and the native application;
sending the request for the access token to the native application via the secure authentication channel;
causing the native application to obtain the access token from a token service on a remote server over a network connection;
causing the native application to provide the access token to the first web-based nested application via the secure authentication channel;
sending a request to access content on the resource server and the access token from the first web-based application to the resource server; and
performing one or more actions on the content on the resource server in response to obtaining access to the content on the resource server.

9. The method of claim 8, wherein the secure communication channel is implemented using JavaScript to establish communications between the first web-based application and the native application.

10. The method of claim 8, further comprising:
obtaining an application programmer interface (API) key from the native application, the API key being a unique identifier that is provided to trusted nested applications to permit the trusted nested applications to request and receive access tokens.

11. The method of claim 10, further comprising:
generating the API key using a key generator of the native application, wherein the API key is a Universally Unique Identifier (UUID).

12. The method of claim 11, further comprising:
determining that the first web-based application is included in a list of applications trusted by the native application; and
providing the API key to the first web-based application responsive to determining that the first web-based application is included in the list of applications trusted by the native application.

13. The method of claim 8, further comprising:
obtaining context information from an intermediate nested frame disposed between the first web-based application and the native application, the context information including information for establishing the secure authentication channel between the first web-based application and the native application.

14. The method of claim 8, further comprising:
sending a request to a platform broker implemented by an operating system of the client device to obtain the access token; and
receiving the access token from the platform broker implemented by the operating system of the client device.

15. A data processing system comprising:
a processor; and
a machine-readable storage medium storing executable instructions that, when executed, cause the processor alone or in combination with other processors to perform operations of:
receiving a request for an access token from a first web-based nested application hosted by a host web-based application in a web browser on a client device, the access token providing access to content on a resource server remote from the client device;
creating a secure authentication channel between the first web-based nested application and the host web-based application, the secure authentication channel bypassing one or more intermediary nested applications between the first web-based nested application and the host web-based application to prevent the one or more intermediary nested applications from accessing data exchanged between the first web-based nested application and the host web-based application;
sending the request for the access token to the host web-based application via the secure authentication channel;
causing the host web-based application to obtain the access token from a token service on a remote server over a network connection;
causing the host web-based application to provide the access token to the first web-based nested application via the secure authentication channel;
sending a request to access content on the resource server and the access token from the first web-based application to the resource server; and
performing one or more actions on the content on the resource server in response to obtaining access to the content on the resource server.

16. The data processing system of claim 15, wherein the secure authentication channel is implemented using JavaScript to establish communications between the first web-based application and the host web-based application.

17. The data processing system of claim 15, wherein the machine-readable storage medium further includes instructions configured to cause the processor alone or in combination with other processors to perform operations of:
obtain an application programmer interface (API) key from the host web-based application, the API key being a unique identifier that is provided to trusted nested applications to permit the trusted nested applications to request and receive access tokens.

18. The data processing system of claim 17, wherein the machine-readable storage medium further includes instructions configured to cause the processor alone or in combination with other processors to perform operations of:
generating the API key using a key generator of the host web-based application, wherein the API key is a Universally Unique Identifier (UUID).

19. The data processing system of claim 18, wherein the machine-readable storage medium further includes instructions configured to cause the processor alone or in combination with other processors to perform operations of:
determining that the first web-based application is included in a list of applications trusted by the host web-based application; and
providing the API key to the first web-based application responsive to determining that the first web-based application is included in the list of applications trusted by the host web-based application.

20. The data processing system of claim 15, wherein the machine-readable storage medium further includes instructions configured to cause the processor to perform operations of:
obtaining context information from an intermediate nested frame disposed between the first web-based application and the host web-based application, the context information including information for establishing the secure authentication channel between the first web-based application and the host web-based application.
